(19) United States
(12) Patent Application Publication
(10) Pub. No.: US 2023/0134434 A1
(43) Pub. Date: May 4, 2023

(54) SEPARATOR, PREPARATION METHOD AND BATTERY

(71) Applicant: ZHUHAI COSMX BATTERY CO., LTD., Zhuhai (CN)

(72) Inventors: Yuede PAN, Zhuhai (CN); Suli LI, Zhuhai (CN); Junyi LI, Zhuhai (CN); Yanming XU, Zhuhai (CN)

(73) Assignee: ZHUHAI COSMX BATTERY CO., LTD., Zhuhai (CN)

(21) Appl. No.: 18/147,220

(22) Filed: Dec. 28, 2022

Related U.S. Application Data
(63) Continuation of application No. PCT/CN2021/108696, filed on Jul. 27, 2021.

(30) Foreign Application Priority Data
Jul. 27, 2020 (CN) 202010731437.8

(51) Int. Cl. H01M 50/446; H01M 50/491

(52) U.S. Cl. CPC H01M 50/446; H01M 50/491; H01M 10/0525

(57) ABSTRACT

Disclosed are a separator and a battery. The separator includes a porous substrate, functional particles, and a coating layer. The functional particles are filled up in internal pores of the porous substrate, and the coating layer is arranged on the upper and lower surface of the porous substrate; the functional particles are oxides of which the outer layers comprise —NH or —NH₂ groups. As the functional particles are contained in the separator, the —NH— or —NH₂ groups can effectively adsorb an acidic substance in a lithium ion battery; the acid content in the lithium ion battery is reduced, and hydrophilic groups on the outer layers of the functional particles can improve the wettability of an electrolyte, increase lithium ion channels, and improve a liquid retention rate of the separator. Therefore, the separator provided in the present disclosure can improve cycling performance and safety performance.

### CROSS-REFERENCE TO RELATED APPLICATIONS

This application is a continuation of International Application No. PCT/CN2021/108696, filed on Jul. 27, 2021, which claims priority to Chinese Patent Application No. 202010731437.8, filed on Jul. 27, 2020. The disclosures of the aforementioned applications are hereby incorporated by reference in their entireties.

### TECHNICAL FIELD

The present disclosure relates to a separator, its preparation method and a battery including the separator, and relates to the technical field of electrochemical devices.

### BACKGROUND

With the continuous development of lithium-ion battery related technologies, the lithium-ion battery has become a very widely used secondary battery. Since lithium hexafluorophosphate needs to be used as the electrolyte in the lithium-ion battery, during preparation of the electrolyte, it is inevitable that hydrofluoric acid will be entrained into the lithium-ion battery, and in a working process of the lithium-ion battery, lithium salts in the electrolyte will inevitably produce acidic substances, for example, lithium difluorooxalate borate and lithium bisoxalate borate may produce boric acid. When the acid content in the lithium-ion battery exceeds a specific concentration, lithium ions starts to be consumed, which will increase the irreversible capacity of the battery, and make the cycling performance of the lithium-ion battery worse. In addition, the gas generated by the reaction will also lead to increase of internal pressure of the lithium-ion battery, which affects the safety of the lithium-ion battery.

Since a large amount of electrolyte in a lithium-ion battery is adsorbed in the separator, in view of damages to cycling performance and safety performance of the lithium-ion battery caused by an acidic substance in the electrolyte, how to provide a separator that may improve performance of the lithium-ion battery has received more and more attention.

### SUMMARY

The present disclosure provides a separator, which is used to solve a problem of damage to the cycling performance and safety performance of a lithium-ion battery by acidic substances.

A first aspect of the present disclosure provides a separator, and the separator includes a porous substrate, functional particles and a coating layer. The functional particles are filled up in internal pores of the porous substrate, and the coating layer is arranged on an upper surface and a lower surface of the porous substrate;

the functional particles are oxides with outer layers including an —NH— group or —NH₂ group.

The present disclosure provides a separator including a porous substrate, functional particles and a coating layer. The porous substrate may be selected from existing materials, such as a polymer separator commonly used in the conventional technology. Because the porous substrate has some pores inside the structure, the present disclosure uses oxides with outer layers including an —NH— or —NH₂ group as functional particles, and the functional particles are filled up in the internal pores of the porous substrate. The —NH— or —NH₂ group in the outer layer of functional particles may effectively adsorb the acidic substances inside the lithium-ion battery, thereby reducing the acid content and reducing an impact of acidic substances on the lithium-ion battery. In order to further ensure the effect of functional particles, in the present disclosure the coating layer is arranged on the upper surface and lower surface of the porous substrate, so that the functional particles are effectively encapsulated inside the porous substrate. The material of the coating layer may also be selected according to the conventional technology, such as polymer particles or ceramics. The separator provided in the present disclosure contains functional particles inside, and the —NH— or —NH₂ group in the outer layer of the functional particles may effectively adsorb the acidic substances inside the lithium-ion battery and reduce the acid content in the lithium-ion battery, thereby reducing the acid content of the lithium-ion battery. Moreover, the hydrophilic group in the outer layer of the functional particles may improve the wettability of the electrolyte, increase the lithium-ion channel, and improve the liquid retention rate of the separator. Therefore, the separator provided in the present disclosure may improve cycling performance and safety performance of the lithium-ion battery. In addition, since the functional particles are filled up in the internal pores of the porous substrate, the thickness of the separator is not increased, so that the energy density of the lithium-ion battery is not greatly affected.

In a specific embodiment, the average pore size of the porous substrate is D1, Dv50 of the functional particles is D2, and Dv50 of the material of the coating layer is D3, where 1.2*D2<D1<0.8*D3.

Further, Dv50 of the material of the coating layer is less than or equal to 1 μm.

The porous substrate in the present disclosure may be selected from a polymer separator commonly used in the conventional technology. Specifically, the porous substrate may include one or more of polyethylene, polypropylene, polyvinylidene fluoride, aramid, polyethylene terephthalate, polytetrafluoroethylene, polyacrylonitrile, polyimide, polyamide, polyester, and natural fibers.

The material of the coating layer in the present disclosure may also be selected according to the conventional technology, for example, the material of the coating layer include one or both of polymer particles or ceramics.

After study, it is found that, if the thickness of the coating layer is too low, an expected effect cannot be achieved; if the thickness of the coating layer is too high, the thickness and weight of the separator are increased, which is not conducive to the energy density of the lithium-ion battery. Therefore, the thickness of the coating layer ranges from 0.1 μm to 6 μm, for example, 0.1 μm, 1 μm, 2 μm, 3 μm, 4 μm, 5 μm, 6 μm.

Further, the functional particles are oxides with outer layer including an —NH— or —NH₂ group, and the functional particles contain elements such as C, H, O, N, and Si. The functional particles are prepared by the following process.

The functional particles are obtained by grafting an oxide with a hydroxyl group on an outer layer with chlorosilanes and then reacting with an organic matter containing —NH— or —NH₂.

The functional particles includes an inorganic oxide in the inner layer and an organic matter containing —NH— or —NH₂ in the outer layer, and the organic matter containing —NH— or —NH₂ is grafted to the inorganic oxide.

The functional particles provided in the present disclosure are oxides with outer layer including an —NH— or —NH₂ group. Specifically, an inorganic oxide with a hydroxyl group in the outer layer is selected as the substrate. For most inorganic oxides, the outer layers all contain a hydroxyl group, and those skilled in the art may directly perform a next processing, or or perform acid treatment on the inorganic oxide to increase the content of hydroxyl groups in the outer layer. For example, when the oxide is SiO₂, acid treatment may be performed on SiO₂ first to increase the hydroxyl content of the outer layer of the SiO₂, and secondly, after the oxides with a hydroxyl group on an outer layer react with chlorosilanes, the reaction product is reacted with an organic matter containing —NH— or —NH₂ to obtain the functional particles. For the convenience of expression, an organic-oxide containing —NH— or —NH₂ is used to represent the functional particles, such as PEI-SiO₂, that is, the oxide in the functional particles is SiO₂ and the organics is PEI (polyethyleneimine).

Further, the oxides include one or more of Al oxide, A100H, Si oxide, Ti oxide, Zn oxide, Mg oxide, Ni oxide, Zr oxide, Ca oxides, and Ba oxide.

The organic matter containing —NH— or —NH₂ includes a polyamine compound and a derivative thereof.

Specifically, the organic matter containing —NH— or —NH₂ includes one or more of hexamethylenediamine (HMDA), p-phenylenediamine (PDA), methyl m-phenylenediamine (MPDA), diethylenetriamine (DETA), triethylene tetramine (TETA), poly-m-aminostyrene, polyethyleneimine (PEI), and hexadecylamine (HDA).

Taking PEI-SiO₂ for example, the preparation method of the functional particles is as follows.

First, the SiO₂ was added to the HNO₃ solution for acid treatment to increase the hydroxyl content of the outer layer of the SiO₂. Secondly, a specific amount of toluene is added into the acidified SiO₂, and toluene and chlorosilanes, such as 3-chloropropyltriethoxysilane, are added into the SiO₂ slowly under the protection of N₂. After reaction, the mixed solution was filtered by suction filtration and dried to obtain silica grafted with chlorosilanes. Finally, the obtained silica grafted with chlorosilanes was added to an aqueous solution of methanol and polyethyleneimine (PEI), the reaction was terminated after stirring and refluxing, and the functional particles PEI-SiO₂ may be obtained after suction filtration, washing and drying.

After preparing the functional particles and selecting the materials of the porous substrate and the coating layer, the separator provided in the present disclosure may be prepared according to the conventional technology, which specifically includes the following steps:

contacting the porous substrate with the dispersion system containing the functional particles, filling the functional particles into the internal pores of the porous substrate, and then arranging a coating layer on the upper surface and the lower surface of the porous substrate to obtain the separator.

In the preparation method provided in the present disclosure, first, a dispersion system of functional particles is prepared, and secondly, functional particles are filled into the internal pores of the porous substrate, for example, the porous substrate is immersed in the dispersion system containing functional particles, or by spraying, so that the functional particles enter the internal pores of the porous substrate separator, and finally the separator is obtained by applying the material of the coating layer onto the upper surface and the lower surface of the porous substrate according to the conventional technology.

Specifically, in the preparation process, functional particles may usually be dissolved in a solvent to obtain a dispersion system containing functional particles, and the applicant has found that when the solid content of the dispersion system is less than 0.1%, the content of functional particles filled to the porous substrate internal pores is lower, and too much solvent is not conducive to the volatilization of the subsequent solvent. When the solid content of the dispersion system is higher than 10%, the distribution of functional particles in the porous substrate internal pores is difficult to be uniform, which may lead to blockage of functional particles. Therefore, in the preparation process, the solid content of the dispersion system of functional particles needs to be controlled to be 0.1%-10%, for example, 0.1%, 1%, 2%, 3%, 4%, 5%, 6%, 7%, 8%, 9%, 10%.

In addition, the solvent used in the dispersion system is a non-aqueous liquid, and it should be noted that the boiling point of the solvent should be within 60˜99° C. (measured under 0.1 MPa), for example, 60° C., 65° C., 70° C., 75° C., 80° C., 85° C., 90° C., 95° C., 99° C. When the boiling point of the solvent is lower than 60° C., the solvent is volatile, and not conducive to operation, and may also lead to the aggregation and accumulation of functional particles. When the boiling point of the solvent is higher than 99° C., which is not conducive to the subsequent volatilization of the solvent, and difficult to completely volatilize the solvent.

Since the positive active materials in the active layer are all polar inorganic substances containing oxygen, the polarity and dielectric constant of the non-aqueous liquid should be in an appropriate range. When the dielectric constant of the non-aqueous liquid is lower than 10, the polarity of the liquid is too weak, and it is difficult to form effective wetting with the active material. When the dielectric constant is higher than 40, the polarity of the solvent is too strong, and may contain strong polar groups such as carboxylic acids, which are easy to react with the positive active material, so the dielectric constant of the solvent at room temperature should be range from 10 to 40, for example, 10, 15, 20, 25, 30, 35, 40.

It may be understood that the solvent cannot react with functional particles.

Specifically, the solvent may include one or more of hexane, tetrahydrofuran, trifluoroacetic acid, 1,1,1-trichloroethane, carbon tetrachloride, ethyl acetate, butanone, benzene, acetonitrile, 1,2-dichloroethyl alkane, methanol, ethanol, ethylene glycol dimethyl ether, trichloroethylene, triethylamine, propionitrile and heptane.

The solvent may be dried under reduced pressure or heated by blasting, and those skilled in the art may select an appropriate method according to the conventional technology.

In order to further improve the performance of the separator, the applicant found that when the porosity of the porous substrate is lower than 20%, the liquid absorption performance of the separator is poor, resulting in the congestion of lithium ion conduction channels, thereby affecting the kinetic performance of the lithium-ion battery. When the porosity of the porous substrate is higher than 90%, the mechanical properties of the separator will be deteriorated, reducing the production yield of the lithium-ion battery, such as the winding process. Therefore, the porosity of the porous substrate ranges from 20% to 90%, for example, 20%, 30%, 40%, 50%, 60%, 70%, 80%, 90%.

The method for measuring the porosity of the porous substrate is as follows: a specific area of the separator is cut out and dried in a vacuum drying oven at 80° C. for 2 h, then is taken out and cooled in a desiccator before testing. First, a micrometer is used to measure the thickness of the sample, and the apparent volume of the sample is calculated based on the surface area and thickness of the sample, denoted as V1; then the AccuPyc II true density meter is used to measure the true volume of the separator, denoted as V2; the porosity of the porous substrate=100%×(V1−V2)/V1.

The gas permeability (Gurley) of the separator ranges from 120 s to 600 s, for example, 120 s, 200 s, 300 s, 400 s, 500 s, 600 s. Gas permeability is an indicator that characterizes the gas permeability of the separator, which can indirectly reflect the permeability of ions. The Gurley value is used as the evaluation standard, namely, the time that a specific volume of gas passes through the separator with a specified area under a specific pressure when the separator is placed in the gas permeability detector. The Japanese industrial standard of the separator industry is used herein, that is, the time required for 100 ml of gas to pass through a 1 square inch separator under a pressure of 1.22 kPa is detected by a Gurley 4110N gas permeability detector.

To sum up, the present disclosure provides a separator, because the interior of the separator contains functional particles, the —NH— or —NH₂ group in the outer layer of the functional particles may effectively adsorb the acidic substances inside the lithium-ion battery, reducing the acid concentration of the lithium-ion battery and effects of acidic substances. Moreover, the hydrophilic group in the outer layer of the functional particles may improve the wettability of the electrolyte, increase the lithium-ion channel, and improve the liquid retention rate of the separator. Therefore, the separator provided in the present disclosure may improve the cycling performance and safety performance of lithium-ion battery. In addition, since the functional particles are filled up in the internal pores of the porous substrate, the thickness of the separator is not increased, so that the energy density of the lithium-ion battery is not greatly affected.

A second aspect of the present disclosure provides a preparation method of any of the above separators, comprising the following steps:

the porous substrate is contacted with the dispersion system containing the functional particles, and then a coating layer is arranged on an upper surface and a lower surface of the porous substrate to obtain the separator.

In the preparation method provided in the present disclosure, firstly, the dispersion system of functional particles is prepared, and then the functional particles are filled into the internal pores of the porous substrate, for example, the porous substrate is immersed in the dispersion system containing functional particles, or by spraying, so that the functional particles enter the internal pores of the porous substrate separator, and finally the separator is obtained by applying the material of the coating layer onto the upper surface and the lower surface of the porous substrate according to the conventional technology. The preparation method provided in the present disclosure has a relatively low preparation cost, which is beneficial to reducing the preparation cost and large-scale production.

A third aspect of the present disclosure provides a lithium-ion battery, including any of the separators described above.

A third aspect of the present disclosure provides a lithium-ion battery. On the basis of the separator provided in the present disclosure, those skilled in the art may prepare a lithium-ion battery with a positive electrode plate, a negative electrode plate, and an electrolyte solution according to the conventional technology. The lithium-ion battery provided by the present disclosure contains functional particles in the separator, and the —NH— or —NH₂ group in the outer layer of the functional particles may effectively adsorb the acidic substances inside the lithium-ion battery, thereby reducing the acid concentration of the lithium-ion battery, and reducing the influence of acidic substances. Moreover, the hydrophilic group in the outer layer of the functional particles may improve the wettability of the electrolyte, increase the lithium ion channel, and improve the liquid retention rate of the separator. Therefore, the present disclosure provides a lithium-ion battery, which has good cycling performance and safety performance.

The implementation of the present disclosure has at least the following advantages.

1. Since the separator provided in the present disclosure contains functional particles inside, the —NH— or —NH₂ group in the outer layer of the functional particles may effectively adsorb the acidic substances inside the lithium-ion battery and reduce the acid content in the lithium-ion battery, thereby reducing the influence of acidic substances. Moreover, the hydrophilic groups in the outer layer of functional particles may improve the wettability of the electrolyte, increase the lithium ion channel, and improve the liquid retention rate of the separator. Therefore, the separator provided in the present disclosure may improve the cycling performance and the safety performance of the lithium-ion battery. In addition, since the functional particles are filled in the internal pores of the porous substrate, the thickness of the separator is not increased, so that the energy density of the lithium-ion battery is not greatly affected.

2. In the present disclosure, a coating layer is arranged on the upper surface and the lower surface of the porous substrate, so that the functional particles are effectively encapsulated inside the porous substrate and the cycling performance of the lithium-ion battery is guaranteed.

3. The preparation method provided in the present disclosure has low cost and is suitable for large-scale production.

4. The lithium-ion battery provided in the present disclosure has better cycling performance and safety performance.

### DETAILED DESCRIPTIONS OF THE EMBODIMENTS

In order to make the purpose, technical solutions and advantages of the present disclosure clearer, the technical solutions in the embodiments of the present disclosure will be clearly described below in combination with the embodiments of the present disclosure. Obviously, the described embodiments are part of the implementation of the present disclosure, but not all embodiments. Based on the embodiments of the present disclosure, all other embodiments obtained by those of ordinary skill in the art without creative efforts shall fall within the protection scope of the present disclosure.

In the following examples, the porous substrate is Celgard 2320 separator (the thickness is 20 μm, the Gurley value is 530 s, the porosity is 39%, the average pore size is 27 nm, and the areal density is 10 g/m²); the coating layer material was purchased from Arkema Reagent Co., Ltd.; the chemical reagents required for preparation of functional particles were purchased from Alfa-Aesar Reagent Co., Ltd.; the pore size was measured by pore size analyzer PMI CFP-1500AE.

### Example 1

The separator provided in this example includes a porous substrate, functional particles and a coating layer.

The functional particles are PEI-SiO₂, Dv50 is 20 nm, an areal density is 0.2 g/m².

The material of the coating layer is PVDF-HFP, Dv50 is 105 nm, and the thickness of the coating layer arranged on each of the upper surface and the lower surface of the porous substrate is 1 μm.

The gas permeability of the separator is 620 s.

The preparation method of functional particles is as follows.

1. 15 g of nano-silica (Dv50=20 nm) was added to 125 mL of HNO₃ solution and stirred at 60° C. for 6 h, then the obtained nano-silica was filtered under reduced pressure, washed with deionized water until being neutral, and dried to obtain activated dioxide silicon, where a concentration of the HNO₃ solution is 1 mol/L.

2. 2 g of activated silica was weighed and added into 80 mL of toluene under the protection of N₂, and stirred at 100° C., then 70 mL of toluene and 5 mL of 3-chloropropyltriethoxysilane were slowly added into the above mixture and reacted for 48 h. The above obtained mixed solution was filtered by suction filtration, methanol Soxhlet extraction for 6 h, suction filtration, and vacuum dried at 50° C. for 12 h to obtain silica grafted with chlorosilanes.

3. 1 g of silica grafted with chlorosilanes was weighed and added into 100 mL of methanol, and the mixed solution was heated up to 60° C., then 5 mL of 50% polyethyleneimine (PEI) aqueous solution was added to the above mixed solution and stirred and refluxed for 24 h to terminate the reaction. The mixed solution was filtered and washed until being neutral and then vacuum dried at 50° C. for 12 h to obtain the functional particles PEI-SiO₂.

Deionized water, 1 mol/L of sulfuric acid, deionized water, 1 mol/L of ammonia water, and deionized water are used for washing in sequence until neutrality is achieved, and finally methanol is used for washing.

The preparation method of the separator provided in this example is as follows.

The functional particles obtained by the above method were dissolved in anhydrous ethanol to obtain a dispersion system containing functional particles, and the porous substrate was soaked in the dispersion system containing functional particles, so that the functional particles enter the internal pores of the substrate separator, and then the upper and lower surfaces of the porous substrate were provided with a coating layer PVDF-HFP to obtain the separator.

### Example 2

The separator provided in this example includes a porous substrate, functional particles and a coating layer.

The functional particles are PEI-Al₂O₃, Dv50 is 10 nm, and an areal density is 0.1 g/m².

The material of the coating layer is PVDF-HFP, Dv50 is 40 nm, and the thickness of the coating layer arranged on each of the upper surface and the lower surface of the porous substrate is 0.1 μm.

The gas permeability of the separator is 570 s.

The preparation method of the functional particles of PEI-Al₂O₃ in this example is as follows:

1. 2 g of nano-Al₂O₃ (Dv50 is 10 nm) was weighed and added into 50 mL of toluene, then 50 mL of toluene and 10 mL of 3-chloropropyltriethoxysilane were added into the obtained mixture while stirring at 105° C. under the protection of N₂, and reacted for 12 h, the mixed solution was filtered by suction filtration, methanol Soxhlet extraction for 3 h, suction filtration, and vacuum dried at 80° C. for 24 h to obtain Al₂O₃ grafted with chlorosilanes.

2.2 g of Al₂O₃ grafted with chlorosilanes was weighed and added into 150 mL of methanol, the mixture was heated up to 70° C., and then 5 mL of 50% polyethyleneimine (PEI) aqueous solution was further added into the obtained mixture, stirred and refluxed for 6 h to terminate the reaction. The mixed solution was filtered and washed until being neutral, and dried under vacuum at 80° C. for 12 h to obtain PEI-Al₂O₃. In the washing process, deionized water, 0.01 mol/L of sulfuric acid, deionized water, 0.5 mol/L of ammonia water, deionized water, and methanol were used in sequence.

The preparation method of the separator in this example is similar to that in Example 1, and the difference lies in that different materials are used.

### Example 3

The separator provided in this example includes a porous substrate, functional particles and a coating layer.

The functional particles are PEI-TiO₂, Dv50 is 5 nm, and an areal density is 0.05 g/m²;

The material of the coating layer is PVDF-HFP, Dv50 is 1000 nm, and the thickness of the coating layer arranged on each of the upper surface and the lower surface of the porous substrate is 6 μm.

The gas permeability of the separator is 650 s.

For the preparation method of the functional particles in this example, reference may be made to that in Example 2, and the difference is that the oxide used is TiO₂ (Dv50 is 5 nm).

The preparation method of the separator in this example is similar to that in Example 1, and the difference lies in that different materials are u sed.

### Example 4

The separator provided in this example includes a porous substrate, functional particles and a coating layer.

The functional particles are HDA-AlOOH, Dv50 is 10 nm, and an areal density is 0.1 g/m².

The material of the coating layer is PVDF-HFP/AlOOH (with a mass ratio of 1:1), Dv50 of PVDF-HFP is 600 nm, Dv50 of AlOOH is 450 nm, and a thickness of the coating layer arranged on each of the upper and lower surfaces of the porous substrate is 2 μm.

The gas permeability of the separator is 580 s.

The preparation method of functional particles in this Example is similar to that in Example 2, the difference is that the used organic matter containing —NH— or —NH₂ is HDA, and the used oxide is AlOOH (Dv50 is 10 nm).

The preparation method of the separator in this example is similar to that in Example 1, and the difference lies in the different materials used.

### Comparative Example 1

The separator provided in this comparative example includes a porous substrate.

### Comparative Example 2

The separator provided in this comparative example includes a porous substrate and a double-sided coating layer.

The material of the coating layer is PVDF-HFP, Dv50 is 105 nm, and the thickness of the coating layer arranged on each of the upper surface and the lower surface of the porous substrate is 1 μm.

In the present disclosure, the separators provided in the above-mentioned Examples 1˜4 and Comparative Examples 1 and 2 are further prepared into lithium-ion batteries, and the specific preparation method is as follows:

A positive electrode plate, a separator, and a negative electrode plate were stacked in sequence, and the separator was in the middle of the positive electrode plate and the negative electrode plate, and then wound into a bare cell with a thickness of 35 mm, a width of 50 mm, and a length of 75 mm. The bare cell was put into an aluminum-plastic film packaging bag and dried in vacuum at 75° C. for 10 h. Electrolyte was injected to the bare cell and the bare cell was vacuum packaged and left to stand for 24 h. Then, the obtained cell was charged to 3.75V with a constant current of 0.05C, then charged to 4.4V at a current of 0.2C, and charged with constant voltage until the current drops to 0.05C. Then the cell was discharged to 3V at a constant current of 0.2C, and finally charged to 3.8V at a constant current of 1C to complete the preparation of the lithium-ion battery.

A preparation method of the positive electrode plate is as follows.

A positive active material (LCO), a conductive agent (acetylene black (SP)), and a binder (polyvinylidene fluoride (PVDF)) were mixed in a mass ratio of 97:1.5:1.5, and the solvent N-methylpyrrolidone was added into the mixture, followed by mixing and stirring to obtain positive electrode slurry. Then, the positive electrode slurry was uniformly applied onto an upper surface and a lower surface of a positive electrode current collector of aluminum foil, and dried at 120° C. to obtain the positive electrode plate.

A preparation method of the negative electrode plate is as follows.

A negative active material (artificial graphite), a conductive agent (acetylene black (SP)), a binder (styrene-butadiene rubber (SBR)), and a thickener (sodium carboxymethyl cellulose (CMC)) were mixed in a mass ratio of 96:1:1.5:1.5, and the solvent of deionized water was added to the mixture and stirred and mixed uniformly to obtain negative electrode slurry. The above negative electrode slurry was uniformly applied onto an upper surface and a lower surface of a negative electrode current collector of copper foil, and dried at 90° C. The obtained plates were cold-pressed, followed by trimming, cutting, slitting, and drying at 110° C. for 4 h under vacuum conditions to obtain the negative electrode plate.

A preparation method of the electrolyte is as follows.

Dimethyl carbonate (DMC), ethyl methyl carbonate (EMC) and ethylene carbonate (EC) were mixed in a mass ratio of 2:1:1 to obtain an electrolyte solution, and then an electrolyte salt was further added into the mixed solution. A concentration of lithium hexafluorophosphate in the electrolyte is 1 mol/L.

The present disclosure tests the capacity retention rate and high-temperature storage gas production performance of the lithium-ion batteries obtained on the basis of Examples 1˜4 and Comparative Examples 1 and 2, and the test results are shown in Table 1.

The test methods for the high temperature cycle capacity retention rate of lithium-ion battery is as follows.

In a constant-temperature box at 60° C., the battery was charged to a voltage of 4.4V at a constant current with a rate of 1 C, then charged to a current of 0.05C at a constant voltage of 4.3V, and then discharged to a voltage of 3.0V at a constant current with a rate of 1C. The obtained discharge capacity was recorded as the battery capacity Cl tested in the first cycle, and the process was repeated to obtain the cycle capacity of the 500^{th} cycle, denoted as Cn.

The capacity retention rate corresponding to the 500^{th} cycle capacity=100%*Cn/Cl.

The test method of high-temperature storage gas production of the lithium-ion battery is as follows:

Six lithium-ion batteries provided by each group of examples and comparative examples were taken and charged to above 4.4V at a constant current with a rate of 0.2C at room temperature and further charged at a constant voltage of 4.4V until the current was lower than 0.05 C, so that the lithium-ion batteries were fully charged at 4.4V. The internal pressure of the fully charged battery before storage was tested and recorded as P1. The fully charged batteries were then stored in an oven at 85° C., and then taken out after 15 days. After the battery cells were cooled for 1 h, the internal pressure of the battery after storage was measured and recorded as Pn.

According to the formula: ΔP=Pn−P1, a pressure change value before and after the battery storage was calculated.

TABLE 1
Performance test results of lithium-ion batteries provided by
Examples1~4 and Comparative Examples 1 and 2

| | Capacity retention | High temperature |
|---|---|---|
| | rate (%) | storage gas (MPa) |
| Example 1 | 94.6 | 0.19 |
| Example 2 | 93.7 | 0.24 |
| Example 3 | 93.2 | 0.27 |
| Example 4 | 93.9 | 0.25 |
| Comparative Example 1 | 89.5 | 0.36 |
| Comparative Example 2 | 92.1 | 0.34 |

As may be seen from Table 1, the capacity retention rates of the lithium-ion batteries provided in Examples 1˜4 are all higher than those of the lithium-ion batteries provided in Comparative Example 1 and 2, and the gas production change values in high-temperature storage in Examples 1˜4 are also lower than those in Comparative Example 1 and 2. It may be learned that the separator provided in the present disclosure may effectively improve the cycling performance and safety performance of a lithium-ion battery.

Finally, it should be noted that the above embodiments are only used to illustrate the technical solutions of the present disclosure, but not to limit them. Although the present disclosure has been described in detail with reference to the foregoing embodiments, those of ordinary skill in the art should understand that: the technical solutions described in the foregoing embodiments can still be modified, or some or all of the technical features thereof can be equivalently replaced. However, these modifications or replacements do not make the essence of the corresponding technical solutions deviate from the technical solutions scope of the embodiments of the present disclosure.

What is claimed is:

1. A separator, comprising a porous substrate, functional particles, and a coating layer, wherein the functional particles are filled in internal pores of the porous substrate, and the coating layer is arranged on an upper surface and a lower surface of the porous substrate; and the functional particles are oxides with outer layers comprising an —NH— group or —NH₂ group.

2. The separator according to claim 1, wherein an average pore size of the porous substrate is D1, Dv50 of the functional particles is D2, and Dv50 of a material of the coating layer is D3, wherein 1.2*D2<D1<0.8*D3.

3. The separator according to claim 2, wherein D3 is less than or equal to 1 μm.

4. The separator according to claim 1, wherein the functional particles comprises an inorganic oxide in the inner layer and an organic matter containing —NH— or —NH₂ in the outer layer, and the organic matter containing —NH— or —NH₂ is grafted to the inorganic oxide.

5. The separator according to claim 4, wherein the oxide comprise one or more of Al oxide, AlOOH, Si oxide, Ti oxide, Zn oxide, Mg oxide, Ni oxide, Zr oxide, Ca oxide, and Ba oxide.

6. The separator according to claim 4, wherein the organic matter containing —NH— or —NH₂ comprises a polyamine compound and a derivative thereof.

7. The separator according to claim 6, wherein the organic matter containing —NH— or —NH₂ comprises one or more of hexamethylenediamine, p-phenylenediamine, methyl m-phenylenediamine, diethylenetriamine, triethylene tetramine, poly-m-aminostyrene, polyethyleneimine, and hexadecylamine.

8. The separator according to claim 4, wherein the functional particles is PEI-SiO₂, whose organic matter is polyethyleneimine and oxide is SiO₂.

9. The separator according to claim 1, wherein the functional particles are obtained by a preparation method comprising the following process: grafting an oxide with a hydroxyl group on an outer layer with chlorosilanes, and then reacting with an organic matter containing —NH— or —NH₂ to obtain the functional particles.

10. The separator according to claim 1, wherein the porous substrate comprises one or more of polyethylene, polypropylene, polyvinylidene fluoride, aramid, polyethylene terephthalate, polytetrafluoroethylene, polyacrylonitrile, polyimide, polyamide, polyester, and natural fibers.

11. The separator according to claim 1, wherein the porosity of the porous substrate ranges from 20% to 90%.

12. The separator according to claim 1, wherein a material of the coating layer comprises one or both of polymer particles or ceramics.

13. The separator according to claim 1, wherein the thickness of the coating layer ranges from 0.1 μm to 6 μm.

14. The separator according to claim 1, wherein the gas permeability of the separator ranges from 120 s to 600 s.

15. A preparation method of the separator according to claim 1, comprising the following process:
contacting the porous substrate with a dispersion system containing the functional particles, and then arranging a coating layer on the upper surface and the lower surface of the porous substrate to obtain the separator.

16. The preparation method according to claim 15, wherein the functional particles are obtained by a preparation method comprising the following process: grafting an oxide with a hydroxyl group on an outer layer with chlorosilanes, and then reacting with an organic matter containing —NH— or —NH₂ to obtain the functional particles.

17. The preparation method according to claim 15, wherein the functional particles is PEI-SiO₂, which is obtained by a preparation method comprising the following process:
adding SiO₂ into HNO₃ solution for acid treatment to increase the hydroxyl content of the outer layer of the SiO₂;
adding a specific amount of toluene into the acidified SiO₂, and then adding toluene and chlorosilanes slowly under the protection of N₂;
after reaction, filtering the obtained mixed matter and drying the obtained solid matter to obtain silica grafted with chlorosilanes;
adding the obtained silica grafted with chlorosilanes into an aqueous solution of methanol and polyethyleneimine, stirring and refluxing the obtained reaction mass, and then terminating the reaction; and
filtering the obtained mixed matter, washing and drying the obtained solid matte to obtain the functional particles PEI-SiO₂.

18. The preparation method according to claim 15, wherein the solvent used in the dispersion system is a non-aqueous liquid, and the boiling point of the solvent is within 60˜99° C. when measured under 0.1 MPa; and/or,
the dielectric constant of the solvent used in the dispersion system at room temperature ranges from 10 to 40.

19. A battery, comprising the separator according to claim 1.

20. The battery according to claim 19, wherein the battery is a lithium-ion battery.
